(19) United States
(12) Patent Application Publication
(10) Pub. No.: US 2004/0259557 A1
(43) Pub. Date: Dec. 23, 2004

(54) Method and system for changing bandwidth based on an existing bandwidth selection

(76) Inventor: Dawn-Marie Bey, New Orleans, LA (US)

Correspondence Address: KILPATRICK STOCKTON LLP, 607 14TH STREET, N.W., WASHINGTON, DC, 20005, US

(21) Appl. No.: 10/870,918

(22) Filed: Jun. 21, 2004

Related U.S. Application Data
(60) Provisional application No. 60/479,845, filed on Jun. 20, 2003.

(51) Int. Cl. H04Q 7/20

(52) U.S. Cl. 455/447; 455/445; 455/446

(57) ABSTRACT

A method for automatically selecting a frequency includes determining when a current frequency has fallen out of an optimal transmission range based on location and facilitating the selection of a second frequency. The selection of a second frequency is facilitated by a comparison of attributes of the current frequency with attributes of possible choices for a second frequency. The comparison attributes may include frequency licensee information, programming type information and programming specific information.

### CROSS-REFERENCE TO RELATED APPLICATIONS

The current applications claims priority to and incorporates by reference in its entirety U.S. Provisional Patent Application Ser. No. 60/479,845 entitled METHOD AND SYSTEM FOR CHANGING BANDWIDTH BASED ON AN EXISTING BANDWIDTH SELECTION, filed on Jun. 20, 2003.

### BACKGROUND OF THE INVENTION

1. Field of the Invention

In general, the current invention relates to the switching of radio frequencies. More particularly, the invention relates to the automatic switching of radio frequencies due to loss of signal, according to a user's listening preferences.

2. Description of the Related Art

Current systems and methods for selecting and receiving specific local frequencies, e.g., radio frequencies, require a user to tune in to a specific frequency. During trips wherein, for example, a driver moves from one receiving area to a second receiving area, the driver eventually loses a selected station and must search through the radio dials in order to find a frequency containing the same, or at least comparable, type of transmission, i.e., type of music, sports station, news station, religious station, foreign language station, and the like. Most radio signals can only travel about 30 or 40 miles from their source.

Further, in many situations, simply using the automatic scanning function on the receiver, i.e., radio, does not pick up many stations that could be found if the exact frequency was known to the user and dialed into the receiver directly.

Further still, a frequency in a first receiving area often has sister frequencies in a multitude of other receiving areas. Individuals traveling through multiple receiving areas often do not know the sister frequencies and thus are unable to tune into the sister station as they are leaving the first receiving area and entering the second receiving area.

Also currently available in the industry are satellite radios, wherein a user must subscribe to a pre-established, limited number of programming stations that are transmitted via satellite. Listeners are not able to pick up local stations using satellite radio services. This system does not utilize the totality of the established local area transmitter/receiver configurations that define the AM (amplitude modulation) and FM (frequency modulation) radio architecture. In fact, each of the limited number of companies offering satellite radio has established different infrastructures for transmitting and receiving their specific programming. Satellite radio does not and cannot transmit local programming.

Consequently, there is a need in the art for a system and method for changing local bandwidth or frequency based on the current local bandwidth or frequency selection.

### SUMMARY OF THE INVENTION

In a first embodiment of the present invention, a system for automatically selecting a frequency is described. The system includes a receiver configured to receive frequencies within a predetermined transmission level range; a processor configured to determine when a first frequency is no longer within a predetermined transmission level range and further configured to initiate a search for a second frequency that is within the predetermined threshold level range; a location identification system configured to determine the location of the receiver; a database containing first information related to the first frequency and second information related to multiple other frequencies, wherein the database stores the first and second information as a function of location; and further wherein the processor is configured to compare the first information to the second information within the database based on the location of the receiver in order to automatically select the second frequency that is within the predetermined threshold level range from the multiple other frequencies.

In a second embodiment of the present invention, a method for automatically selecting a frequency is described. The method includes receiving a first frequency having a location-sensitive transmission level at a receiver; comparing the location-sensitive transmission level of the first frequency to a predetermined optimal transmission level range on a continuous basis; initiating a search for a second frequency that is within the optimal transmission level range when the location-sensitive transmission level of the first frequency falls out of the predetermined optimal transmission level range; determining the location of the receiver; and

comparing first information for the first frequency with second information for multiple other frequencies within the optimal transmission level range to determine at least one selection for the second frequency based on the location of the receiver.

### BRIEF DESCRIPTION OF THE DRAWINGS

FIG. 1 is a flowchart depicting the operation of a preferred embodiment of the present invention;

FIG. 2 is a flowchart depicting the operation of a preferred embodiment of the present invention; and

FIG. 3 is a graphical representation of a preferred embodiment in operation.

### DOCUMENTS INCORPORATED BY REFERENCE

The following information is incorporated herein by reference in its entirety:

“How to Apply for a Broadcast Station”—pages 1-9; http://www.fcc.gov/mb/audio/getstat.html;

“How Radio Works”—pages 1-12; http://www.howstuffworks.com/radio.htm/printable;

“How the Radio Spectrum Works”—pages 1-3

http://www.howstuffworks.com/radio-spectrum.htm; and

“How GPS Receivers Work”—pages 1-9 http://www.howstuffworks.com/gps.htm.

### DETAILED DESCRIPTION OF THE INVENTION

The first embodiment will be described with respect to radio frequencies, but this embodiment is not intended to be limiting. Radio frequencies are licensed and monitored by the Federal Communications Commission (“FCC”). As of Jun. 30, 2002, the FCC listed more than 13,000 AM and FM radio stations. Due to transmitter locations and the signal characteristics of radio wavelengths, the same frequency may be, and usually is, assigned to many different parties, wherein the parties are located in different transmitting/receiving areas. Similarly, a single entity may transmit the same or similar content over many different frequencies, each frequency being in a different transmitting/receiving area.

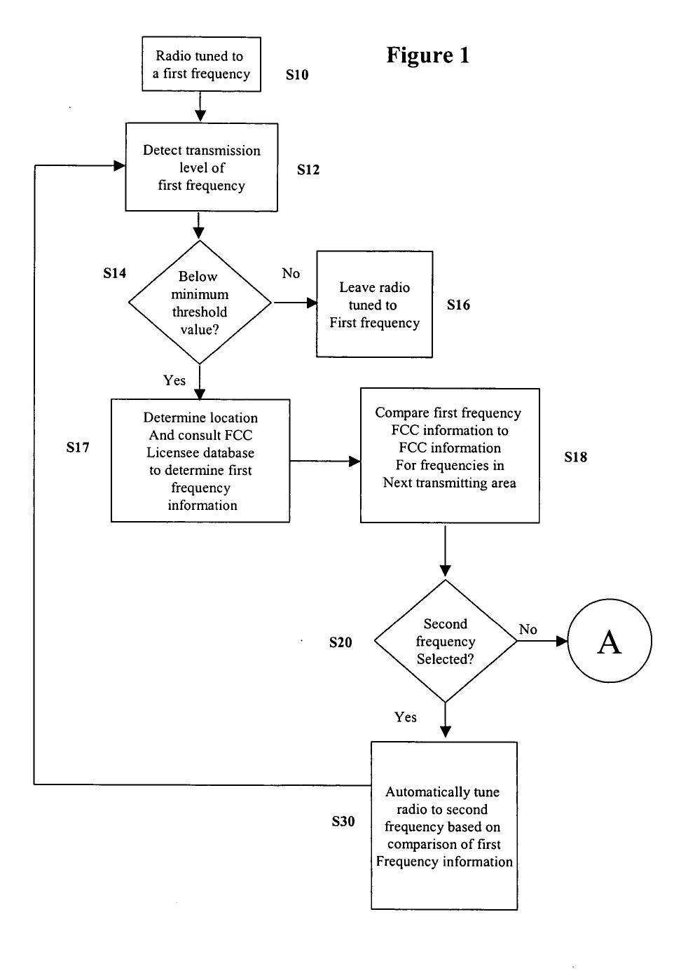

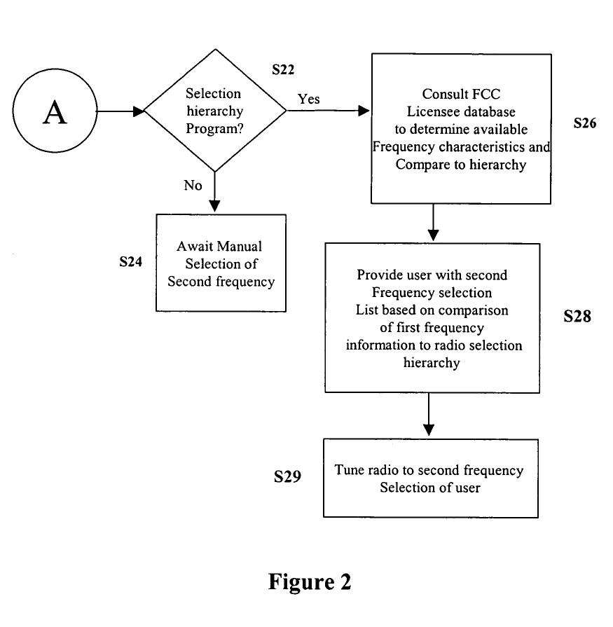

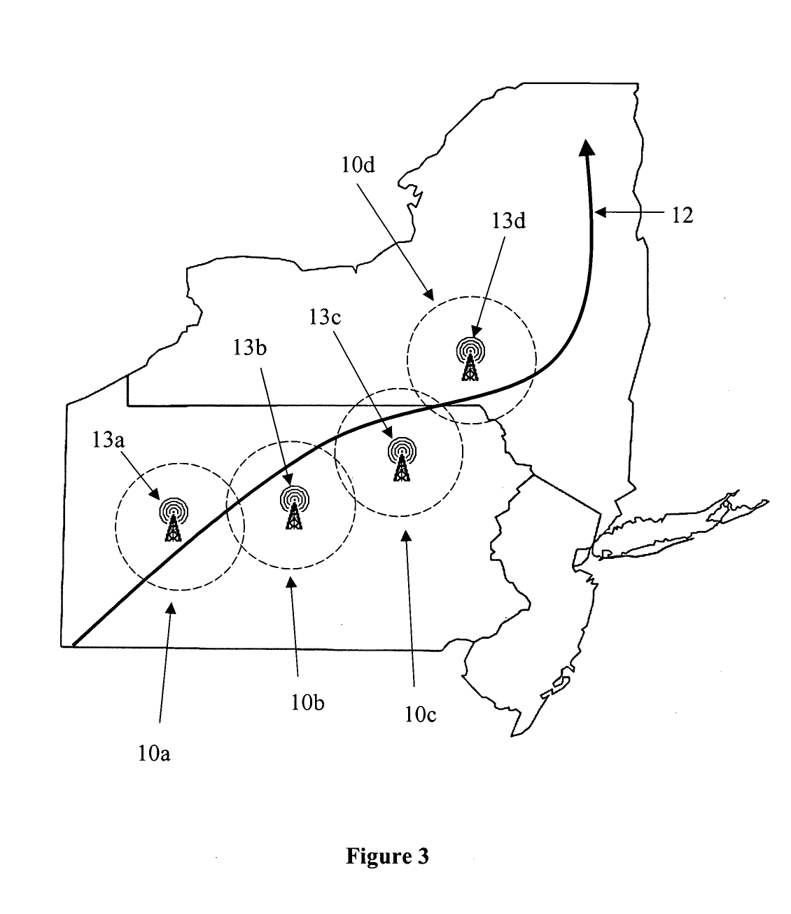

Referring to FIGS. 1, 2 and 3 an exemplary preferred embodiment of the present invention is described. FIG. 3 depicts an exemplary travel path 12 which might take a user through multiple transmitting/receiving areas 10a-10d. According to this exemplary embodiment of the present invention, a system comprising a receiver, hereafter termed a radio for exemplary purposes, is tuned to a first frequency by a user, in a first transmitting/receiving area 10a. This process step for tuning to a first frequency is shown in box S10 of FIG. 1. The receiver is able to pick up the first frequency signal via an antenna 13a when the first frequency signal reaches a predetermined threshold level as determined by the receiver. The first frequency signal selected by the user has specific call letters associated therewith and a specific licensee associated therewith. This information is regulated and is available from the FCC.

The receiver constantly detects the transmission level of the first frequency S12 so long as the receiver is tuned to the first frequency. The receiver compares the first frequency's transmission level to a minimum threshold value, e.g., an optimal transmission value range S14. If the signal strength falls below or out of the optimal transmission value range the threshold value, the first frequency signal is lost. If, however, the signal strength stays above the threshold value or within the transmission value range, the receiver stays tuned to the first frequency S16. According to the embodiments of the present invention, the system further includes a processor associated with the receiver, i.e., radio, that is configured so as to determine when the first frequency level is within a predetermined range of being lost, i.e., is about to drop below the necessary threshold level for reception or some other minimum threshold value or range (S14). Referring to FIG. 3, frequencies emitted from the transmitter 13a within the first transmitting/receiving area 10a, are eventually lost when the user passes into the second transmitting/receiving area 10b.

In a first particular embodiment of the present invention, when the first frequency drops below the threshold level, the system utilizes a processor to access a database or databases to determine whether a second frequency is available which matches the characteristics of the first frequency S20. More particularly, the processor identifies the descriptive information about the first frequency level and compares the descriptive information to the data tables containing local programming identification information S17. The processor contains a database of all FCC licensed radio stations. The system also includes a global positioning system (GPS) or other location identification system (hereafter referred to generically as “GPS”). Using its memory of the first transmission wavelength of the first frequency level in conjunction with radio's, i.e., vehicle's, GPS coordinates, the processor is able to consult a database of licensed radio stations within the transmission region of the current GPS coordinate of the user S17. Further, the database, or databases as needed, contain other tables that include descriptive information about the licensed radio stations in addition to the approximate range of transmission for the current GPS coordinates. This other information may include sponsorship information, e.g., ESPN radio, CBS News radio, or the like; a brief description of programming material, e.g., sports, news, talk radio, types music, religious programming, and the like; language information, e.g., Spanish, English, etc. Additionally, the consulted database or databases need not necessarily exist within the receiver, but instead may exist at secondary locations and may be accessed in real-time by the receiver wirelessly, e.g., through radio frequency (“RF”), Wi-Fi (“wireless fidelity), infrared (“IR”) and other exemplary telemetric configurations. Further still, the receiver databases may be updated periodically with new or revised frequency information either wirelessly or through user downloading.

The receiver automatically selects or, alternatively prompts a user to select, a licensed station in the GPS coordinate transmission/reception area having identification characteristics that are identical to or similar to the characteristics of the station found at the first frequency S20. The processor directs a tuner of the system of the first particular embodiment to at least a second frequency having the identical or similar characteristics to the first frequency, as depicted in box S30. In a particular embodiment, the processor uses an internal rules hierarchy for comparing the identification characteristics. For example, the processor may first look for a second frequency that has specific programming identical to that of first frequency. If there is no second frequency with the specific programming, the processor may next look for a second frequency having an identical licensee to that of the first frequency. Further still, if there is no second frequency with the identical licensee, the processor may next look for a second frequency with a programming type matching the first frequency. In the case where there are multiple stations, i.e., multiple frequencies, with in the GPS coordinate transmission/reception area that have identical or similar characteristics, the processor directs the tuner to automatically scan through the selected multiple frequencies, thus allowing the user/listener to select which of the frequencies contain programming that the user would like to hear.

After tuning to this second frequency, the system again detects the transmission level of the frequency (S12). If the signal at this frequency goes below a minimum threshold value (S14), the system again accesses the database (S17) to find another frequency to select (S20). Referring to representative FIG. 3, at least steps S14-S20 are repeated when the user leaves second transmitting/receiving area 10b and enters third transmitting/receiving area 10c, etc.

By way of particular example, it is possible to drive across multiple GPS coordinate transmission/reception areas during the course of an athletic event, e.g., a football game, that is being broadcast under a nationally recognized licensee, e.g., ESPN radio. Employing the system of the present invention, a user, when passing from one GPS coordinate transmission/reception area to the next, need not attempt to scan through the entire radio bandwidth in an attempt to find the football game on another station. According to the present invention, the system described herein would automatically attempt to find a station containing the identical or similar content, e.g., the football game, on a station in the next GPS coordinate transmission/reception area.

In a second particular embodiment, when the processor determines that the first frequency level has dropped below a predetermined threshold frequency for reception and that there is not an identical or almost identical second frequency for the current transmitting/receiving area, the processor next checks to see if the user has programmed a frequency selection hierarchy into the processor S22. If no such hierarchy program is found, then the receiver awaits manual selection of a second frequency by the user S24. If a user selection hierarchy has been programmed, utilizes the processor to access a database or databases to determine whether a second frequency is available which matches the characteristics of the user selection hierarchy S26. More particularly, the processor identifies the descriptive information about the first frequency level and compares the descriptive information to the data tables containing local programming identification information S26. The system may then either automatically tune to a second frequency based on the hierarchy or provide the user with available selections based on the hierarchy S27 and then tune to a user selection S28.

Further to the embodiments described herein, the processor is remotely updated periodically with particular programming information for each frequency within a GPS coordinate transmission/reception area, so that the processor contains detailed and up-to-date programming information. The processor may be updated by satellite or other wireless means, such as through the uploading of information from a storage device, e.g., disk, CD or the like, to a database of the radio. If updated by satellite or other wireless means, the programming information is updated on a continual real-time basis, i.e., whenever the receiver is within range of the transmitter. As such, the information about available frequencies is always up-to-date. This descriptive frequency information may be provided by the government regulation entity, i.e., the Federal Communications Commission, and/or by the licensees themselves.

In an alternative embodiment of the present invention detailed descriptive information pushed down to the processor may be accessed by the user/listener in the event they wish to learn more about a particular frequency, e.g., licensee information, type of programming, times of programming, listening area, e.g., by showing on a map or by listing GPS coordinates, and the like. This information may be used by the user/listener in helping to set up rules/criteria for determining future frequency selections. For example, in a particular embodiment, the user/listener can pre-program the processor to switch to pre-selected stations during a trip through multiple local listening areas. In essence, the user/listener can establish a listening itinerary by mapping the intended driving path and selecting particular frequencies available along the driving path. Using this feature, the user/driver could conceivably drive across a large area and many, many different local listening areas, e.g., across the United States, without ever needing to physically change the radio station.

In a further embodiment to the present invention, the processor contains a set of rules/criteria for determining how to select a second frequency based on the first frequency. Returning to the specific example set forth above, if the first frequency received in Washington, DC is an ESPN sponsored frequency that is presenting a football game between the Washington Redskins and the Dallas Cowboys the processor can be programmed to present certain choices, in a certain order, for a second frequency once the first frequency drops below the required threshold level for reception. So, for example, when the driver of a vehicle containing a system according to the present embodiment approaches Philadelphia, the first frequency will eventually drop below the threshold level for reception. In this embodiment, the processor could be programmed to automatically switch to the ESPN sponsored station in the new locale.

Alternatively, the processor could be programmed to scan through a series of next choices that are available in the new locale, such as, (1) ESPN sponsored station, (2) stations containing football games, (3) stations containing other sports or sports related content, (4) stations sponsored by Company B, e.g., CBS. As the system scans through the choices, the user/listener is able to select the preferred station through the systems controls, i.e., panel or remote controls. Further, the processor is not limited to either the AM or FM bands, but contains programming information for both bands and can provide choices according to the pre-established rules. These rules could also be used to block out frequencies containing certain types of programming. For example, the processor may be programmed with a rule such that a frequency having a particular sponsor or programming is never presented to the user/listener as a choice.

The above-identified embodiments are intended to be exemplary and are not intended to be limiting. One skilled in the art recognizes the various alternative embodiments that are contemplated by the scope of the invention.

1. A system for automatically selecting a frequency comprising:
a receiver configured to receive frequencies within a predetermined transmission level range;
a processor configured to determine when a first frequency is no longer within a predetermined transmission level range and further configured to initiate a search for a second frequency that is within the predetermined threshold level range;
a location identification system configured to determine the location of the receiver;
a database containing first information related to the first frequency and second information related to multiple other frequencies, wherein the database stores the first and second information as a function of location; and
further wherein the processor is configured to compare the first information to the second information within the database based on the location of the receiver in order to automatically select the second frequency that is within the predetermined threshold level range from the multiple other frequencies.

2. The system according to claim 1, wherein the processor is configured with rules for selecting the second frequency that is above the predetermined threshold level from the multiple other frequencies based on the comparison.

3. The system according to claim 1, wherein the location identification system is a global positioning system.

4. The system according to claim 2, wherein the first and second information include at least one of licensee information, programming type information and programming specific information.

5. The system according to claim 4, wherein the rules are hierarchical and a first rule requires selection of the second frequency from the multiple frequencies when the programming specific information for the first frequency matches the programming specific information for the second frequency.

6. The system according to claim 5, wherein assuming the first rule is not met, a second rule requires selection of the second frequency from the multiple frequencies when the licensee information for the first frequency matches the licensee information for the second frequency.

7. The system according to claim 6, wherein assuming neither the first or second rules are met, a third rule requires selection of the second frequency from the multiple frequencies when the programming type information for the first frequency matches the programming type information for the second frequency.

8. A method for automatically selecting a frequency comprising:
receiving a first frequency having a location-sensitive transmission level at a receiver;
comparing the location-sensitive transmission level of the first frequency to a predetermined optimal transmission level range on a continuous basis;
initiating a search for a second frequency that is within the optimal transmission level range when the location-sensitive transmission level of the first frequency falls out of the predetermined optimal transmission level range;
determining the location of the receiver; and
comparing first information for the first frequency with second information for multiple other frequencies within the optimal transmission level range to determine at least one selection for the second frequency based on the location of the receiver.

9. The method according to claim 8, further comprising selecting the second frequency according to a pre-established set of rules.

10. The method according to claim 9, wherein the first information and the second information include at least one of licensee information, programming type information and programming specific information.

11. The method according to claim 10, wherein the rules are hierarchical and a first rule requires selection of the second frequency from the multiple frequencies when the programming specific information for the first frequency matches the programming specific information for the second frequency.

12. The method according to claim 11, wherein assuming the first rule is not met, a second rule requires selection of the second frequency from the multiple frequencies when the licensee information for the first frequency matches the licensee information for the second frequency.

13. The method according to claim 12, wherein assuming neither the first or second rules are met, a third rule requires selection of the second frequency from the multiple frequencies when the programming type information for the first frequency matches the programming type information for the second frequency.

14. The method according to claim 13, wherein assuming none of the first, second or third rules are met, determining if a user-programmed hierarchy exists and selecting the second frequency from the multiple frequencies according to the user-programmed hierarchy.

15. The method according to claim 8, further comprising accessing the first information and the second information wirelessly.

16. The method according to claim 8, further comprising updating the first information and the second information wirelessly.

17. The method according to claim 9, wherein when the step of selecting the second frequency results in multiple selections for the second frequency the method further comprises scanning through the multiple selections for the second frequency.

18. The method according to claim 17, further comprising selecting from the scanned multiple selections for the second frequency.
